(19) United States
(12) Patent Application Publication
(10) Pub. No.: US 2006/0085517 A1
(43) Pub. Date: Apr. 20, 2006

(54) Download user agent plug-in for facilitating over-the-air downloading of media objects

(76) Inventor: Markku Kaurila, Espoo (FI)

Correspondence Address: Hollingsworth & Funk, LLC;Suite 125, 8009 34th Avenue South, Minneapolis, MN, 55425, US

(21) Appl. No.: 10/958,194

(22) Filed: Oct. 4, 2004

(51) Int. Cl. G06F 15/16

(52) U.S. Cl. 709/217

(57) ABSTRACT

A manner of facilitating over-the-air downloading of media objects to devices using browser-independent download user agents. A browser is provided at the communication device to facilitate user discovery of network services offering downloadable content. A download user agent is provided, which is configured as a plug-in capable of communicating with the browser via a plug-in API. The download user agent plug-in initiates requests to retrieve downloadable content, and does so via the plug-in API and browser. The content is retrieved by the browser on behalf of the download user agent plug-in, whereby the download user agent plug-in can install the content on the communication device.

### FIELD OF THE INVENTION

This invention relates in general to the controlled communication of content between networked elements, and more particularly to a system, apparatus, computer program product and method for facilitating over-the-air downloading of media objects to devices using browser-independent download user agents.

### BACKGROUND OF THE INVENTION

New technologies are continually emerging, enabling new types of content to be delivered over mobile networks for use with mobile terminals. These new technologies include messaging technologies such as Short Message Service (SMS), Enhanced Messaging Service (EMS), Multimedia Messaging Service (MMS), e-mail and other messaging technologies. Further, these new technologies have enabled mobile devices to retrieve content from other networks ranging from small networks such as Local Area Networks (LANs) to Global Area Networks (GANs) such as the Internet.

The mobile industry in particular is on the verge of introducing a large-scale Internet-style, media type-independent, download of media objects (i.e. content). These media objects include a variety of different types of content, such as ringing tones, icons, screen savers, games, images, video clips, songs, software tools, JAVA™ MIDlets, etc. The Open Mobile Alliance (OMA) is a consortium that is involved in the development of an industry-wide specification for developing applications that operate over wireless networks to assist in the transfer of such content. For example, the OMA Specification entitled “Generic Content Download Over The Air Specification,” Version 1.0 (20 Jun. 2002) concerns a download technology for confirmed download that is used to deliver digital content such as applications as well as objects to be rendered to mobile terminals. The OMA Download model leverages the Hypertext Transfer Protocol (HTTP) download mechanisms, and adds additional tools for content negotiation, well-formalized (protocol-independent) metadata presentation, and application layer confirmation of installation.

However, where OMA download user agents in the mobile devices are implemented as part of a browser, such OMA download user agent must be rewritten each time the browser is replaced with another vendor's product. Further, prior art download user agents themselves needs to gain access to the network services to be able to handle the downloading of the media object from a server. The responsibility of network connection and HTTP transaction handling significantly complicates the user agent function, whose primary tasks are different from and independent of such responsibilities.

Accordingly, there is a need in the communications industry for an efficient and flexible manner for retrieving content on wireless devices, while easing the development process and providing scalability. The present invention fulfills these and other needs, and offers various advantages over prior art approaches.

### SUMMARY OF THE INVENTION

To overcome limitations in the prior art described above, and to overcome other limitations that will become apparent upon reading and understanding the present specification, the present invention discloses a system, apparatus, computer program product and method for facilitating over-the-air downloading of media objects to devices using browser-independent download user agents.

In accordance with one embodiment of the invention, a method is provided for delivering content to a communication device over a network. A discovery application (e.g., browser) is provided at the communication device that is capable of facilitating user discovery of a network service(s) offering downloadable content. The communication device also includes a download user agent (DUA) that is capable of requesting retrieval of the downloadable content over the network. The DUA is configured as a plug-in module, capable of communicating with the discovery application via a plug-in Application Programming Interface (API). The DUA plug-in requests retrieval of the downloadable content by way of the discovery application. The content is retrieved via the discovery application, and installed on the communication device by the DUA plug-in.

According to one particular embodiment of such a method, a descriptor file including metadata related to the downloadable content is received at the discovery application, which in response loads the DUA plug-in into memory and executes the DUA plug-in. Downloading protocol information is communicated from the DUA plug-in to the discovery application to effect the retrieval of the content via the discovery application. According to another embodiment, the DUA plug-in requests transmission of an installation notification to the network service by way of the discovery application, and in response the DUA plug-in enables use of the downloaded content. In various embodiments, the discovery application manages some or all of the transactions occurring between the communication device and the network service, such as HTTP, HTTPS, WSP, WTLS, or analogous protocols.

In accordance with another embodiment of the invention, a communication device is provided which is capable of communicating over-the-air with a network. The device includes a processor, and modules executable by the processor including a discovery application, a plug-in API, and a download user agent (DUA) that is configured as a plug-in module. The discovery application is configured to facilitate user discovery of a network service(s) offering downloadable content. The DUA plug-in is configured to communicate with the discovery application via the plug-in API, and is configured to communicate requests for the downloadable content to the discovery application via the plug-in API. The discovery application is further configured to communicate the requests to the at least one network service for the downloadable content on behalf of the DUA plug-in. In this manner, the discovery application manages the network connections and HTTP (or other analogous) transaction handling, thus relieving the download user agent from any such responsibilities.

According to a particular embodiment of such a communication device, the DUA plug-in is configured to communicate further requests to the discovery application via the plug-in API for transmission of an installation notification to the network service, in response to the downloadable content being installed on the communication device. The discovery application communicates the installation notification to the network service on behalf of the DUA plug-in.

In accordance with another embodiment of the invention, a method is provided for delivering a media object(s) to a communication device over a network. A user of the communication device identifies a service offering the media object, and activates (via a browser or other discovery application) a link to a descriptor file which includes download instructions and metadata concerning the media object. The descriptor file is received at the browser via the network in response to activation of the link to the descriptor file. A download user agent (DUA) plug-in is loaded into the browser, where the DUA plug-in capable of communicating with the browser via a plug-in Application Programming Interface (API). The descriptor file is parsed by the DUA plug-in, whereby a Uniform Resource Identifier (URI) is identified from which the media object can be downloaded. The DUA plug-in requests retrieval of the media object by way of the browser. The browser thus manages all transactions involved in retrieving the media object that occur between the communication device and the service, and that involve a communication protocol associated with the identified URI (e.g., HTTP, HTTPS, WSP, WTLS, etc.). The DUA plug-in then installs the media object for use on the communication device.

In a more particular embodiment of such a method, the descriptor file is an Open Mobile Alliance (OMA) Download Descriptor, and the communication protocol and associated URI are provided via an ObjectURI attribute of the Download Descriptor. In another particular embodiment, the DUA plug-in installs the media object by preparing the media object for use and disabling use of the media object on the communication device, requesting transmission of an installation notification to the service via the browser which again manages the protocol transactions occurring between the communication device and the service to transmit the installation notification, and receiving via the browser an installation acknowledgement to allow the DUA plug-in to determine whether to enable use of the media object on the communication device.

In accordance with another embodiment of the invention, a system for communicating media objects over a network is provided. The system includes a presentation server(s), a download server(s), and a mobile device(s). The presentation server presents a download service offering downloading of at least one media object. The download server stores the media object, and stores descriptor files including metadata and download instructions relating to the media object. The mobile device is capable of communicating over-the-air with the presentation server and the download server via the network. The mobile device includes a processor, and various modules executable by the processor including a browser, a plug-in API, and a download user agent (DUA) configured as a plug-in. The browser is configured to facilitate user discovery of the download service by way of the presentation server. The DUA plug-in is configured to communicate with the browser via the plug-in API, and to communicate a request(s) for the media object(s) provided by the download service to the browser via the plug-in API. The browser communicates the requests to the download server that provides the download service, in order to obtain the media object on behalf of the DUA plug-in.

In accordance with another embodiment of the invention, a computer-readable medium is provided to store a download user agent (DUA) plug-in module in accordance with the invention. The computer-readable medium stores instructions that are executable by a computing system in a mobile device to retrieve media objects from a download server. The executable instructions perform steps including receiving, from a browser by way of a plug-in Application Programming Interface (API), a Download Descriptor including at least metadata and download instructions associated with a requested media object. The instructions further cause the Download Descriptor to be parsed by the DUA plug-in to identify a Uniform Resource Identifier (URI) from the metadata of the Download Descriptor. The instructions cause the DUA plug-in to issue a request to the browser via the plug-in API in order to retrieve the requested media object from the download server according to the download instructions. The instructions allow the DUA plug-in to receive the requested media object from the browser via the plug-in API, and to install the requested media object on the mobile device. In a more particular embodiment, the instructions further enable the issuance of a second request to the browser via the plug-in API to transmit an installation notification to the download server, in response to installation of the media object on the mobile device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1A is a block diagram illustrating one embodiment of the present invention, where an OMA download user agent is implemented as a browser plug-in;

FIG. 1B illustrates a download plug-in that can be used with different discovery applications or web browsers in accordance with the present invention;

FIG. 2 is a block diagram illustrating a system for downloading a media object(s) in accordance with one embodiment of the present invention;

FIGS. 3A, 3B and 4 illustrate alternative representative embodiments of methods for delivering content to a communication device over a network in accordance with the present invention; and

FIG. 5 illustrates a representative network system implementing principles of the present invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

The present invention provides, among other things, a manner for separating particular functionalities of applications responsible for network connections and transaction handling from applications responsible for managing content downloading functions. To eliminate the need to rewrite such download applications for use with each different application responsible for network connections and transaction handling (e.g., web browsers and other discovery applications), and to reduce the complexity of such download applications, the present invention provides a download user agent as a plug-in to the web browser, discovery application, or other application otherwise responsible for managing network connections and transaction handling via a network. By doing so, transaction complexity is hidden from the download user agent, and the download user agent can be implemented as an independent, browser-independent module that can be re-used with any appropriate plug-in Application Programming Interface (API)-compliant web browser or other discovery application.

Embodiments of the present invention are described in terms of Open Mobile Alliance (OMA) Download technology to facilitate an understanding of the invention. However, the present invention is applicable to analogous content download methodologies where download user agents are utilized in connection with web browsers and other discovery applications. Further, while embodiments of the invention are described in terms of web browsers, this is intended to include any discovery application used by a device user to discover content, services, pages and documents, and/or other information available via a network. For example, a web browser as used herein includes browser applications used to locate information via the World Wide Web (WWW), via Wireless Access Protocol (WAP) browsers, or other analogous programs that provide a way to view, navigate and/or interact with information available on one or more networks.

The OMA is an alliance of companies designed to be the center of mobile service enabler specification work, that assists in the creation of interoperable services across countries, operators, and mobile terminals that will meet the needs of the end user. The OMA download is a technology for “confirmed” download transactions that is used to deliver digital content such as entertainment and business applications as well as objects to be rendered to mobile devices/terminals. Currently the OMA download model leverages the Hypertext Transfer Protocol (HTTP) download mechanisms, and provides additional tools for content negotiation, well-formalized (i.e., protocol independent) metadata presentation, and application layer confirmation of installation. OMA download is based on a Download Descriptor (DD), and includes metadata related to the download transaction that is typically delivered separately from the media object it references. As is known in the art, “metadata” generally refers to a component of data which describes the data; i.e., it is data about data.

A client-side implementation of the OMA download standard involves providing a download application in the mobile terminal/device. For example, some platforms may include a requirement to include a client-side implementation of the OMA download standard in mobile terminals. Such devices may be equipped with a fully functional web browser, which is capable of rendering Hypertext Markup Language (HTML) and/or Extensible Hypertext Markup Language (XHTML) pages. Thus, a web browser is a representative “discovery application” for downloading services in these kinds of devices. Web browsers are typically third party applications, and can be replaced with web browsers from other vendors.

However, an OMA (or analogous) download user agent has its own role and functional requirements that are separate from the web browser/discovery application. Thus, where an OMA download user agent is implemented as part of the discovery application, it must be rewritten each time the web browser or other discovery application is replaced with another vendor's product. Further, the OMA download user agent, which is responsible for the downloading function itself, needs access to network services to enable handling of the downloading of the media object from the download server(s). Requiring the OMA download user agent to assume the responsibility of managing network connections and transaction handling (e.g., HTTP transaction handling) significantly complicates the OMA download user agent, whose primary tasks are largely unrelated to managing network connections and transaction handling. The present invention addresses these and other problems of the prior art.

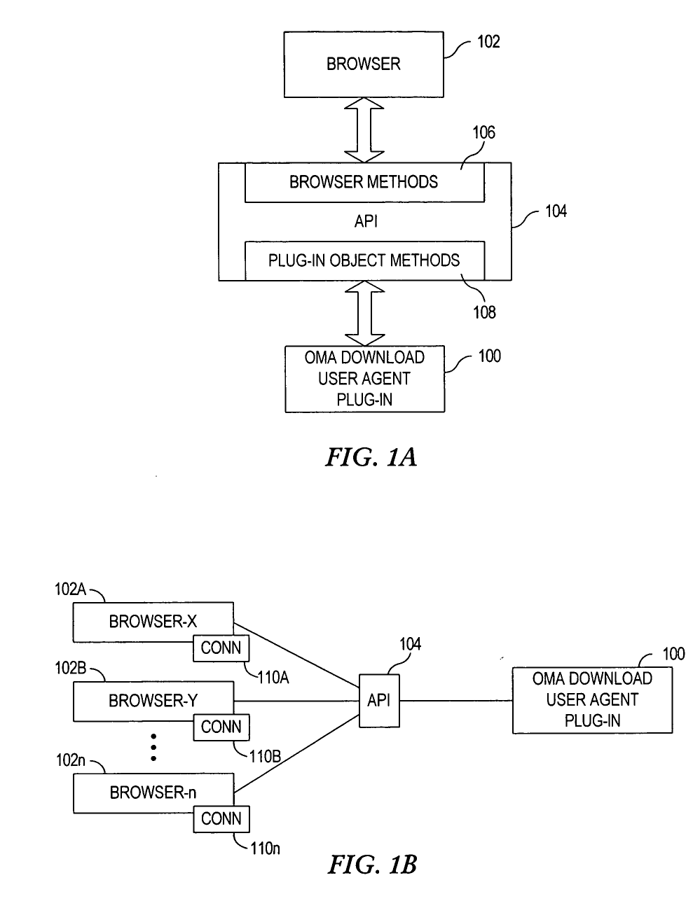

One aspect of the present invention involves implementing a download user agent as a browser plug-in, rather than as part of the browser/discovery application itself. FIG. 1A is a block diagram illustrating one embodiment of the present invention, where an OMA download user agent is implemented as a browser plug-in. More particularly, an OMA download user agent plug-in 100 is provided (hereinafter referred to as a download plug-in). The download plug-in 100 provides functionality that may include, for example, parsing the Download Descriptor (DD), handling capability negotiations, handling the OMA downloading protocol with the download server, and the like. In one embodiment, the discovery application/browser 102 handles all HTTP or analogous transactions between the server and the device, and hides the complexity of all the HTTP communication. Thus, the download user agent does not have direct access to the HTTP stack. Rather, the download plug-in 100 operates as though part of the browser 102, and makes requests to the browser 102 when it is in need of some service(s). More particularly, the browser 102 or other delegated application may check for plug-in modules, and an instance of the download plug-in 100 will be created when a page is accessed by the user that invokes the plug-in 100.

Requests for services and/or other communications between the download plug-in 100 and the browser 102 may be performed by means of a plug-in Application Programming Interface (API) 104. In one embodiment, the plug-in API 104 may be implemented, for example, as the NETSCAPE 4.0 plug-in API. Such an API 104 may include browser methods 106 which are functions called by the download plug-in 100 and implemented by the browser 102. The API 104 may also include plug-in object methods 108, which are called by the browser 102 and implemented in the download plug-in 100.

Thus, where the web browser 102 plays the role of the discovery application, and the OMA download Multi-Purpose Internet Mail Extensions (MIME) type is not natively supported, the present invention can handle incoming descriptor files (e.g., the DD) via the download plug-in 100. The download user agent is thus implemented as the download user agent plug-in 100, which registers the appropriate MIME type into the browser (e.g., text/vnd.oma.dd).

As shown in the embodiment of FIG. 1 B, the present invention provides a download plug-in 100 that can be used with different discovery applications or web browsers 102A, 102B, 102n. Thus, the OMA download user agent plug-in 100 does not need to be rewritten for use with a new, updated, or otherwise different web browser. Communication and transaction handling functions, depicted as COMM 110A, 110B, 110n, can remain at the browser 102A, 102B, 102n, thereby eliminating this responsibility and complexity from the download plug-in 100. Accordingly, the download plug-in 100 can focus on its primary tasks, such as parsing the DD, handling capability negotiations, handling the downloading protocol with the download server, etc.

As will be described with more particularity below, a typical use case involves a user locating one or more pages (e.g., HTML/XHTML page) offering some downloading service(s). The page(s), which include a link to a descriptor file such as the Download Descriptor (DD), may be stored in a presentation server. Upon the user activating the appropriate link, the descriptor file is downloaded into the device. The browser identifies the incoming file as a descriptor, loads the OMA download plug-in into memory, and executes it. The plug-in is responsible for various actions, such as parsing the DD, handling the capability negotiations, and handling the OMA downloading protocol with the download server. It may also be responsible for providing the user with some feedback about the process.

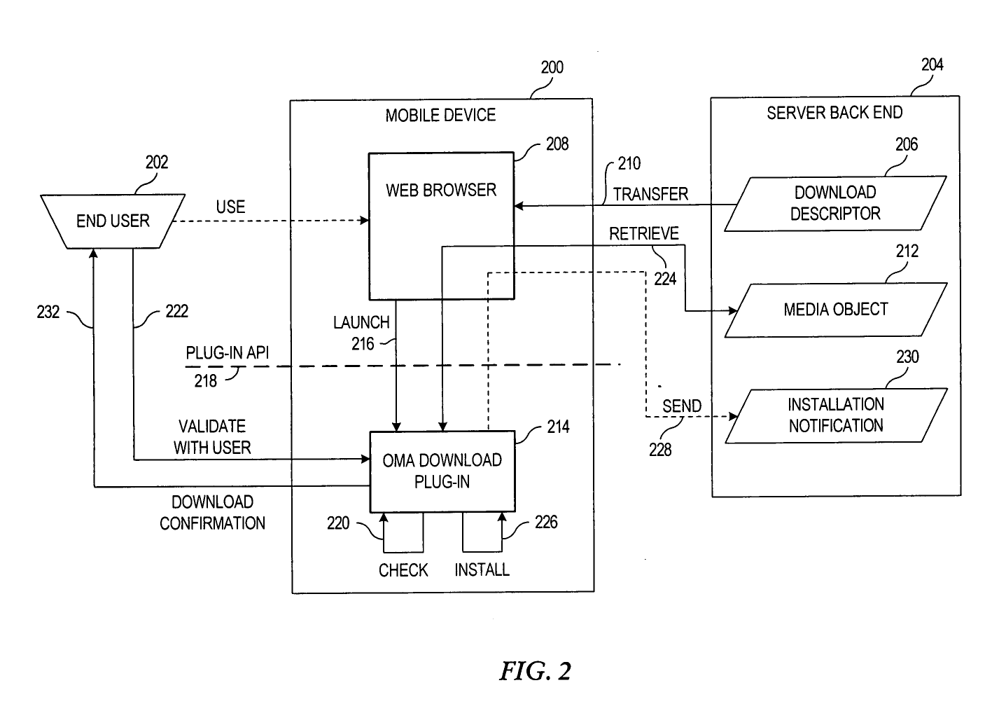

A more particular example is described in connection with FIG. 2, which is a block diagram illustrating a system for downloading a media object(s) in accordance with one embodiment of the present invention. The example of FIG. 2 includes a mobile device 200, which may represent any mobile device such as a mobile phone, Personal Digital Assistant (PDA), portable computing device, or the like. The invention may also be used with desktop or other computing devices that are equipped with the appropriate network communication abilities. FIG. 2 also depicts an end user 202, and a server back end which represents one or more servers to which the mobile device 200 will communicate in the downloading transaction. For example, the Download Descriptor 206 may be stored at a download server, a presentation server, or other appropriate server.

The representative download process of FIG. 2 first involves a user 202 utilizing a browser 208 or other discovery application on the device 200 to find a page(s) offering some downloading service(s). The web browser 208 may communicate with a presentation server (not shown) or other server offering such services. The user selects a link or other Uniform Resource Identifier (URI) that points to the download descriptor (DD) 206, and the DD 206 is transferred 210 to the device 200. The DD 206 includes a link or other URI referencing the media object(s) 212. While in some embodiments the desired media object 212 may be delivered together with the DD 206, it is assumed for purposes of this example that the media object 212 is not delivered with the DD 206. The DD 206 includes metadata relating to the media object(s) 212, and also includes instructions to the download plug-in 214 as to the manner in which the media object 212 is to be downloaded. Receipt of the DD 206 at the browser 208 will cause the browser 208 to launch 216 the download plug-in 214 via the plug-in API 218.

The download plug-in 214 then processes the DD 206. In the OMA context, the DD 206 is parsed and processed according to particular processing rules. Information provided in the DD 206 is then used by the download plug-in 214 to check 220 whether the device 200 is capable of presenting, rendering, executing or otherwise using the media object 212. In one embodiment, certain information relating to the media object 212 may be made available to the user 202, such as the media object 212 name, vendor, size, type, etc. The user can validate 222 or otherwise confirm the download.

Either automatically or upon user validation, the media object(s) 212 can then be retrieved 224 at the behest of the download plug-in 214. In accordance with the invention, this retrieval is not directly provided to the download plug-in 214, but rather is provided to the browser 208 and ultimately provided to the download plug-in 214 by way of the browser 208 and plug-in API 218. More particularly, the browser 208 handles all HTTP (or analogous) transactions between the server(s) 204 and the device 200, and hides the complexity of the HTTP (or analogous) communication. The download plug-in 214 does not, therefore, have direct access to the HTTP stack in this embodiment. Instead, the plug-in 214 makes requests to the browser 208 when it requires a service. The communication between the browser 208 and the plug-in 214 is facilitated using the plug-in API 218.

The download plug-in 214 installs 226 the media object 212; i.e. it prepares the media object 212 for rendering, execution and/or other use. Where an installation notification is not requested or required for the particular download, the download is complete and the media object 212 can be used accordingly. An installation notification may be required by, for example, information in the DD 206. In such cases, the “installation” 226 is essentially a pre-installation where the media object(s) 212 is prepared for use, without actually allowing its use on the device 200. Then, in accordance with the present invention, the download plug-in 214 sends 228 an installation notification 230 to the download server 204 or other designated server, which is initiated at the download plug-in 214 but sent via the browser 208. Again, the download plug-in 214 is relieved of any transactions between the server 204 and the device 200, and requests the browser 208 via the plug-in API 218 to perform this task. In one embodiment, the media object(s) 212 is available for use at the device 200 if the installation notification 230 is successful. The download plug-in 214 may then provide a download confirmation 232 to the end user 202 to indicate the availability of the media object(s) 212. In one embodiment, no such confirmation 232 is required where the DD 206 does not include a request for an installation notification 230.

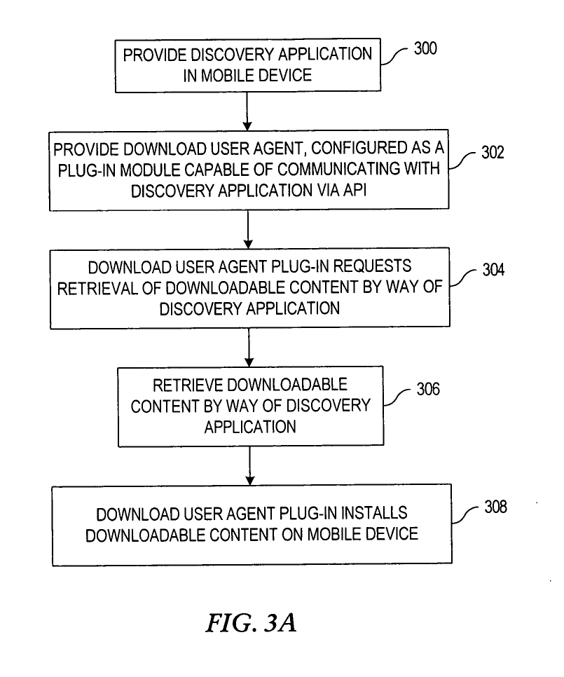

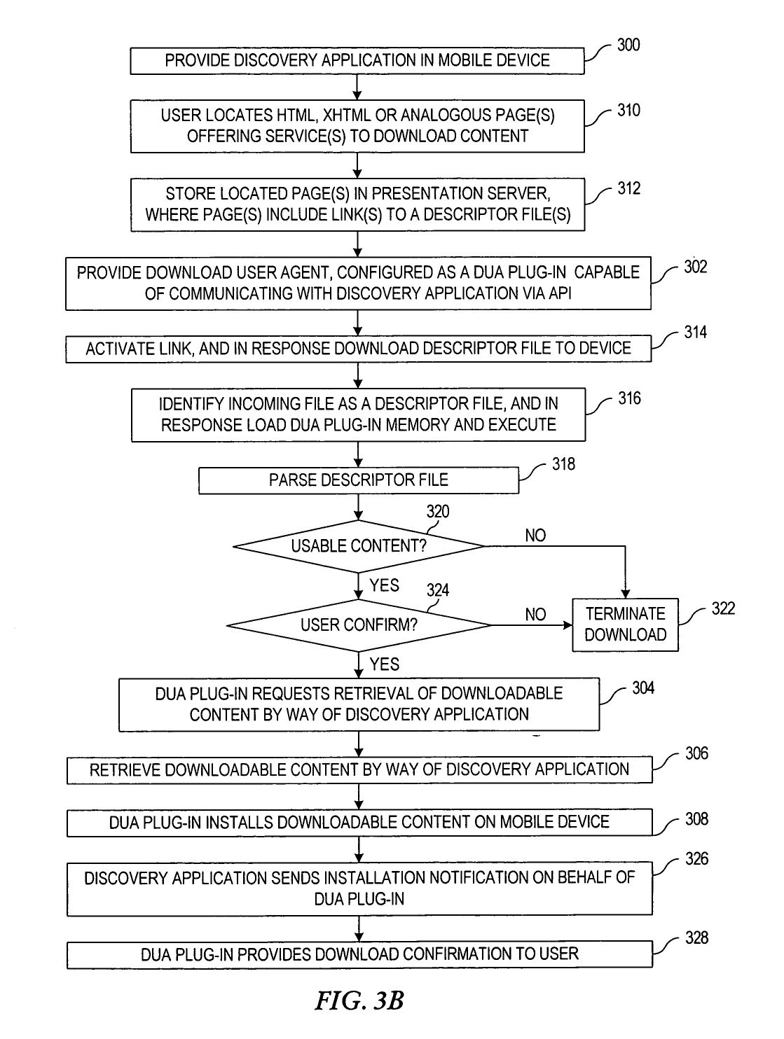

FIG. 3A illustrates a representative embodiment of a method for delivering content to a communication device over a network in accordance with the present invention. In the illustrated embodiment, the communication device is assumed to be a mobile device capable of engaging in wireless communication over a network, where such “network” may include one or more interworking networks such as cellular networks, data networks, the Internets, local area networks, and the like. A discovery application is provided 300 in the mobile device. The discovery application may represent a browser application, such as a web browser, WAP browser, or other browsing application which enables the user to perform any one or more of locating, viewing, navigating or otherwise browsing documents or “pages” available via the network. The discovery application may alternatively (or further) be an application that is specifically designed for use in locating, downloading, or otherwise making use of a certain type(s) of content, such as, for example, an application specifically created to locate songs via an online music service(s). Other examples of a discovery application may include communications/messaging applications, such as a Multimedia Messaging Service (MMS) application or other application that presents links to the user to retrieve the Download Descriptors or other similar metadata. Any such application that can perform/request services for handling HTTP and other similar transactions, and that can load the download plug-in of the invention, may represent the discovery application.

A download user agent is provided 302, which is configured as a plug-in module capable of communicating with the discovery application via an Application Programming Interface (API). Referred to herein as a download user agent (DUA) plug-in, this module may be responsible for various functions such as parsing the Download Descriptor, handling the capability negotiations, and handling the OMA downloading protocol with the download server. It may also be responsible for providing the user with feedback regarding the download process. However, the DUA plug-in need not be burdened with the responsibility of establishing and/or maintaining network connections or handling communication protocols such as Hypertext Transfer Protocol (HTTP), Hypertext Transfer Protocol Secure (HTTPS), WAP Wireless Transport Layer Security (WTLS), WAP Wireless Session Protocol (WSP), or other analogous transaction handling protocol. For purposes of this description, such communication protocols that relate to the network connections and transaction handling between a discovery application and network elements may be referred to herein as browser-compatible protocols. By configuring the download user agent as a plug-in to the discovery application or browser, the discovery application/browser handles the HTTP (or analogous) transactions between the mobile device and those server(s) that provide the media objects, request/require installation notices, etc.

Thus, the DUA plug-in of such an embodiment does not have direct access to the HTTP stack. Instead, the DUA plug-in makes requests to the discovery application/browser when it requires some service, which significantly reduces the complexity of the download user agent. To retrieve content, the DUA plug-in requests 304 retrieval of downloadable content by way of the discovery application/browser. The browser then handles the network connections and HTTP transactions to the server where the requested content resides. The content is retrieved 306 by way of the discovery application/browser, and the DUA plug-in installs 308 the content on the mobile device.

FIG. 3B illustrates a more particular embodiment of a method for delivering content to a communication device over a network in accordance with the present invention. FIG. 3B makes reference to items in FIG. 3A using like reference numbers where appropriate. A discovery application is provided 300 in the mobile device as described in connection with FIG. 3A. The user locates 310 a page, such as an HTML, XHTML or other page, which offers some downloading service(s) to download content. The page is stored 312 in a presentation server, and includes a link to a descriptor file such as a Download Descriptor (DD). A download user agent, configured as a plug-in module capable of communicating with the discovery application, is provided 302. Either automatically or by way of user selection, the link is activated 314, and in response the descriptor file is downloaded to the device.

The discovery application identifies 316 the incoming file as a descriptor file, and loads the DUA plug-in into memory and executes it. The DUA plug-in parses 318 the descriptor file. Based on information in the descriptor file, the DUA plug-in determines 320 whether the content is usable, and if not the download is terminated 322. If the content is usable, the DUA plug-in may request download confirmation from the user, as determined at decision block 324. If the user does not confirm the download and/or affirmatively denies the download, the download is terminated 322. Otherwise the DUA plug-in requests 304 retrieval of the downloadable content by way of the discovery application, the content is retrieved 306 by way of the discovery application, and the DUA plug-in installs 308 the content on the mobile device as was described in connection with FIG. 3A. In one embodiment, the DUA plug-in communicates to the server, via the discovery application, downloading protocol information to effect the retrieval of the content. Other information may also be communicated, such as device capability information.

The discovery application may send 326 an installation notification to the server on behalf of the DUA plug-in, again delegating the responsibility of handling network connections and HTTP transaction handing to the discovery application. In some embodiments, a successful response to the installation notification is required to activate the content on the mobile device for proper use of the content. The DUA may also provide a download confirmation to the user as illustrated at block 328.

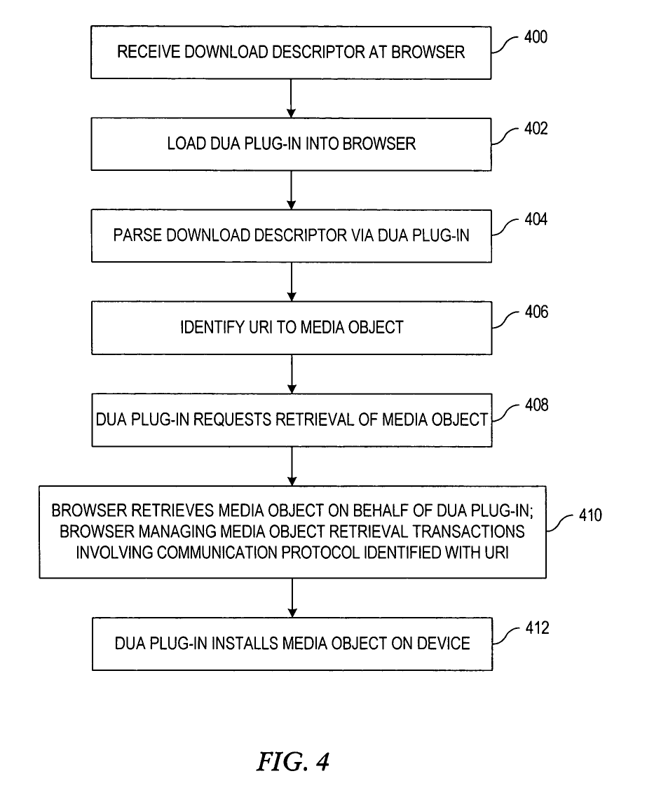

Another embodiment of a method for delivering a media object(s) to a communication device is illustrated in FIG. 4. An OMA Download Descriptor (DD) is received 400 at a browser. The receipt of the DD is a result of activation of a link to the DD in a document or page presented to the user on the communication device. A DUA plug-in is provided, which can communicate with the browser via a plug-in API. The DUA plug-in is loaded 402 in the browser, and the DD is passed to the DUA plug-in to be parsed 404. The DUA plug-in identifies 406 a Uniform Resource Identifier (URI), such as a Uniform Resource Locator (URL) from which the media object(s) can be downloaded.

The DUA plug-in makes a request 408 for the browser to retrieve the media object, and the browser retrieves 410 the media object on behalf of the DUA plug-in. The browser manages the media object retrieval transactions that occur between the communication device and the service providing the media object, and that involve a communication protocol associated with the identified URI. For example, a Download Descriptor attribute “ObjectURI” is defined in the OMA Specification entitled “Generic Content Download Over The Air Specification,” Version 1.0 (OMA-Download-OTA-v1_{—}0-20020620-p; 20 Jun. 2002), which provides the URI from which the media object can be loaded. The associated URI may include a communication protocol such as HTTP, HTTPS, WSP, WTLS, or other identifier of the communication protocol used to connect to the network and manage transactions between the device and the server(s) involved in the media object download. When the media object(s) has been retrieved, the DUA plug-in installs 412 the media object on the device.

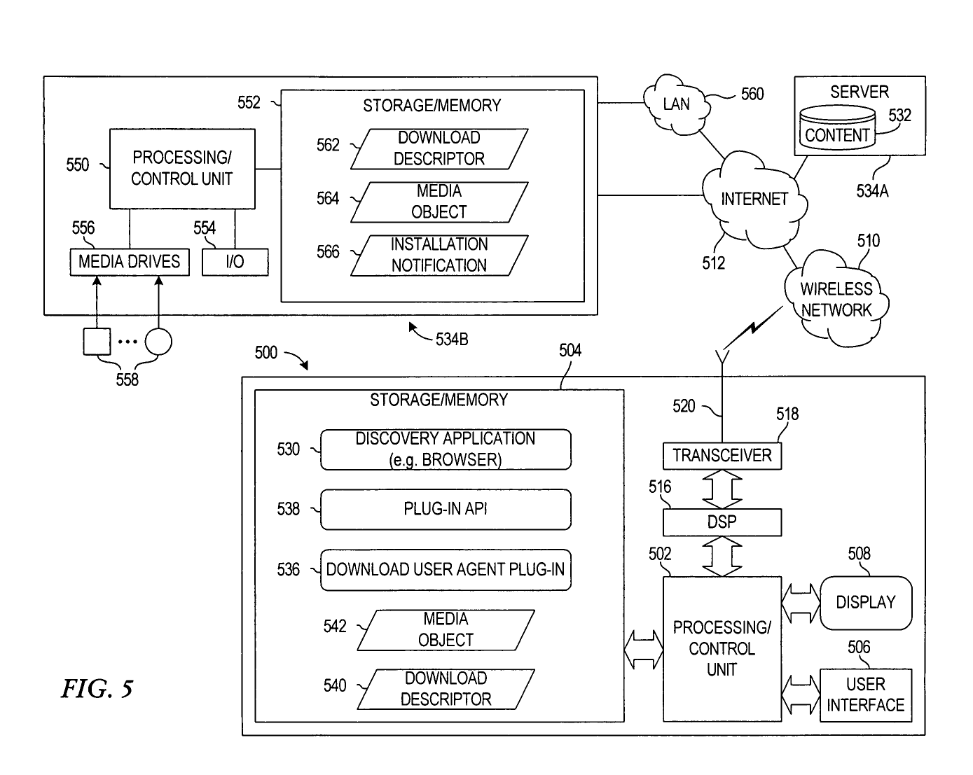

Hardware, firmware, software or a combination thereof may be used to perform the functions and operations in accordance with the invention. The mobile devices in accordance with the invention include communication devices capable of communicating over-the-air (OTA) with wireless networks, and with landline networks by way of the wireless networks. Such mobile devices include, for example, mobile phones, PDAs, and other wireless communicators. The present invention is also applicable to landline computing systems and communicators. A representative system in which the present invention may be implemented or otherwise utilized is illustrated in FIG. 5.

The system includes a mobile device 500 that utilizes computing systems to control and manage the conventional device activity as well as the functionality provided by the present invention. For example, the representative mobile device 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the mobile device 500 as dictated by programs available in the program storage/memory 504. The storage/memory 504 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the mobile device. The storage 504 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile device operations in accordance with the present invention may also be transmitted to the mobile device 500 via data signals, such as being downloaded electronically via one or more networks, such as the Internet 512 or other data networks, and an intermediate wireless network(s) 510.

For performing other standard mobile device functions, the processor 502 is also coupled to user-interface (UI) 506 associated with the mobile device 500. The UI 506 may include, for example, a keypad, function buttons, microphone, joystick, scrolling mechanism (e.g., mouse, trackball), touch pad/screen, or other user entry mechanisms (not shown). These and other UI components are coupled to the processor 502 as is known in the art. A display device 508 is also associated with the mobile device 500, although additional or alternative presentation mechanisms may be implemented (e.g., audio speaker, tactile feedback, etc.).

The mobile device 500 may also include conventional circuitry for performing wireless transmissions over the wireless network(s) 510. The DSP 516 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 518 transmits outgoing radio signals and receives incoming radio signals, generally by way of an antenna 520.

The storage/memory 504 stores the various client programs used in connection with the present invention, such as the local browser 530 or other discovery application to request content 532 from remote servers 534A, 534B. The client programs also include the download user agent plug-in 536 and plug-in API 538. Data may also be stored at the device 500, such as the download descriptor 540 or other descriptor file, as well as the media object 542 that is ultimately downloaded to the device 500. These various mobile device modules are representative of the types of functional modules that may be provided on a mobile device in accordance with the invention, and are not intended to represent an exhaustive list.

FIG. 5 also depicts a representative download server to which the device contacts in order to download the desired media object(s). While multiple servers may cooperatively provide the services and data, FIG. 5 illustrates the download server as a single entity, such as server 534B. It should be recognized, however, that multiple servers may be used to provide the functions and data to the device 500. Thus, the server 534B generically represents any such network element capable of providing and/or assisting with the download functions according to the invention. More particularly, the server 534B includes a processing arrangement 550, which may be coupled to the storage/memory 552. The processor 550 carries out a variety of standard computing functions as is known in the art, as dictated by software and/or firmware instructions. The storage/memory 552 may represent firmware, media storage, and/or memory. The processor 550 may communicate with other internal and external components through input/output (I/O) circuitry 554. The server 534B may also include media drives 556, such as hard and floppy disk drives, CD-ROM drives, DVD drives, and other hardware capable of reading and/or storing information. In one embodiment, software for carrying out the operations at a server 534B in accordance with the present invention may be stored and distributed on CD-ROM, diskette, removable memory, or other form of media capable of portably storing information, as represented by media devices 558. Such software may also be transmitted to the device 534B via data signals, such as being downloaded electronically via a network such as the Internet 512, Local Area Network (LAN) 560, wireless network 510, and/or any combination thereof.

In accordance with one embodiment of the invention, the storage/memory 552 and/or media devices 558 store the various programs and data used in connection with the present invention. FIG. 5 illustrates that a server(s) 534B may store information including the Download Descriptor 562 or other descriptor file containing metadata and/or other information concerning the media object 564. The installation notification 566, if used, is received at the server 534B, and in response an installation acknowledgement may be returned to the device 500.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “computer-readable medium,” “computer program product” or similar terminology as used herein are intended to encompass a computer program(s) that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the methods of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method for delivering content to a communication device over a network, comprising:
providing in the communication device a discovery application capable of facilitating user discovery of at least one network service offering downloadable content;
providing in the communication device a download user agent (DUA) at least capable of requesting retrieval of the downloadable content over the network;
configuring the DUA as a DUA plug-in capable of communicating with the discovery application via a plug-in Application Programming Interface (API);
requesting retrieval, by the DUA plug-in, of the downloadable content by way of the discovery application; and
retrieving the downloadable content by way of the discovery application, and installing the downloadable content on the communication device via the DUA plug-in.

2. The method of claim 1, further comprising:
receiving a descriptor file at the discovery application including metadata concerning the downloadable content;
at the discovery application, loading the DUA plug-in into memory and executing the DUA plug-in; and
communicating at least downloading protocol information from the DUA plug-in to the discovery application to effect the retrieval of the downloadable content by way of the discovery application.

3. The method of claim 2, further comprising communicating at least device capability information from the DUA plug-in to the discovery application to further effect the retrieval of the downloadable content.

4. The method of claim 1, further comprising requesting transmission, by the DUA plug-in, of an installation notification to the network service by way of the discovery application.

5. The method of claim 4, further comprising receiving at the DUA plug-in, by way of the discovery application, a successful installation acknowledgement, and enabling use of the retrieved downloadable content in response thereto.

6. The method of claim 1, further comprising communicating download confirmation information from the DUA plug-in to a user interface of the communications device.

7. The method of claim 1, further comprising the discovery application managing all transactions occurring between the communication device and the network service in connection with the retrieval of the downloadable content that involves a browser-compatible protocol.

8. The method of claim 1, further comprising the discovery application managing all transactions occurring between the communication device and the network service in connection with the retrieval of the downloadable content, and involving any of an HTTP, HTTPS, WSP, or WTLS protocol.

9. The method of claim 1, wherein configuring the DUA as a DUA plug-in comprises configuring the DUA as a DUA plug-in capable of communicating with the discovery application via the plug-in API conforming to the NETSCAPE plug-in API.

10. The method of claim 9, wherein providing a discovery application comprises providing a NETSCAPE plug-in API-compliant discovery application.

11. The method of claim 1, wherein discovery application comprises a browser application.

12. A communication device capable of communicating over-the-air with a network, comprising:
a processor;
a discovery application executable by the processor and configured to facilitate user discovery of at least one network service offering downloadable content;
a plug-in Application Programming Interface (API) executable by the processor;
a download user agent (DUA) configured as a DUA plug-in executable by the processor and configured to communicate with the discovery application via the plug-in API, wherein the DUA plug-in is configured to communicate requests for the downloadable content to the discovery application via the plug-in API; and
wherein the discovery application is further configured to communicate the requests to the at least one network service for the downloadable content on behalf of the DUA plug-in.

13. The communication device as in claim 12, wherein the discovery application is further configured to receive the requested downloadable content, and wherein the DUA plug-in is further configured to install the requested downloadable content on the communication device.

14. The communication device as in claim 13, wherein:
the DUA plug-in is further configured to communicate further requests to the discovery application via the plug-in API for transmission of an installation notification to the at least one network service in response to the installation of the downloadable content on the communication device; and
the discovery application is further configured to communicate the installation notification to the at least one network service on behalf of the DUA plug-in.

15. The communication device as in claim 12, wherein the communication device comprises any of a mobile phone, Personal Digital Assistant (PDA), or portable computing device capable of communicating over-the-air.

16. The communication device as in claim 12, wherein the discovery application comprises a browser application.

17. A method for delivering at least one media object to a communication device over a network, wherein the communication device identifies a service offering the media object, and activates a link to a descriptor file including download instructions and metadata concerning the media object, using a browser operable via the communication device, the method comprising:
receiving the descriptor file at the browser via the network in response to activation of the link to the descriptor file;
loading a download user agent (DUA) plug-in into the browser, the DUA plug-in capable of communicating with the browser via a plug-in Application Programming Interface (API);
parsing the descriptor file via the DUA plug-in, and identifying a Uniform Resource Identifier (URI) from which the media object can be downloaded;
requesting retrieval, by the DUA plug-in, of the media object by way of the browser, wherein the browser manages all transactions involved in retrieving the media object which occur between the communication device and the service and which involve a communication protocol associated with the identified URI; and
the DUA plug-in installing the media object on the communication device.

18. The method of claim 17, wherein the descriptor file comprises an Open Mobile Alliance (OMA) Download Descriptor, and wherein the communication protocol and associated URI are provided via an ObjectURI attribute of the Download Descriptor.

19. The method of claim 17, wherein the DUA plug-in installing the media object comprises the DUA plug-in preparing the media object for use and enabling use of the media object on the communication device.

20. The method of claim 17, wherein the DUA plug-in installing the media object comprises:
preparing the media object for use and disabling use of the media object on the communication device;
requesting transmission, by the DUA plug-in, of an installation notification to the service by way of the browser, wherein the browser manages the protocol transactions occurring between the communication device and the service to transmit the installation notification; and
receiving at the DUA plug-in, by way of the browser, an installation acknowledgement used by the DUA plug-in to determine whether to enable use of the media object on the communication device.

21. The method of claim 17, wherein the communication protocol associated with the identified URI comprises any one of HTTP, HTTPS, WSP, or WTLS.

22. The method of claim 17, wherein parsing the descriptor file via the DUA plug-in further comprises identifying one or more device attributes provided in the descriptor file, and further comprising the DUA plug-in determining whether the communication device is capable of using the media object based on the one or more device attributes and the capabilities of the communication device.

23. The method of claim 22, further comprising the DUA plug-in facilitating user confirmation of an intent to download the media object to the communication device.

24. The method of claim 17, further comprising the DUA plug-in presenting a download confirmation via a user interface of the communication device.

25. A system for communicating media objects over a network, comprising:
a presentation server presenting a download service offering downloading of at least one media object;
one or more download servers storing the media object and descriptor files including at least metadata and download instructions relating to the media object; and
a mobile device capable of communicating over-the-air with the presentation server and the one or more download servers via the network, the mobile device comprising:
a processor;
a browser executable by the processor and configured to facilitate user discovery of the download service via the presentation server;
plug-in Application Programming Interface (API) executable by the processor;
a download user agent (DUA) configured as a DUA plug-in executable by the processor and configured to communicate with the browser via the plug-in API, wherein the DUA plug-in is configured to communicate at least one request for the media object provided by the download service to the browser via the plug-in API; and
wherein the browser is further configured to communicate the requests to the one or more download servers providing the download service to obtain the media object on behalf of the DUA plug-in.

26. A computer-readable medium having instructions stored thereon which are executable by a computing system in a communication device, the executable instructions operable via a processor for retrieving media objects from a download server by performing steps comprising:
receiving, from a browser by way of a plug-in Application Programming Interface (API), a Download Descriptor including at least metadata and download instructions associated with a requested media object;
parsing the Download Descriptor to identify at least a Uniform Resource Identifier (URI) from the metadata of the Download Descriptor;
issuing a request to the browser via the plug-in API to retrieve the requested media object from the download server according to the download instructions;
receiving the requested media object from the browser via the plug-in API; and
installing the requested media object on the communication device.

27. The computer-readable medium as in claim 26, wherein the instructions are further executable to perform steps comprising issuing a second request to the browser via the plug-in API to transmit an installation notification to the download server in response to installation of the media object on the communication device.
